(19) United States
(12) Patent Application Publication
(10) Pub. No.: US 2011/0157075 A1
(43) Pub. Date: Jun. 30, 2011

(54) TOUCH PANEL AND ELECTRONIC DEVICE USING SAME

(75) Inventor: SONG-LING YANG, Shenzhen City (CN)

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/884,203

(22) Filed: Sep. 17, 2010

(30) Foreign Application Priority Data
Dec. 31, 2009 (CN) 200910312796.3

(51) Int. Cl. G09G 3/36; G06F 3/045

(52) U.S. Cl. 345/174; 345/104

(57) ABSTRACT

An electronic device is provided. The electronic device includes a touch panel. The touch panel includes touch units, an oscillator, rectifier circuits, a direct current power, switches, and comparators. Each touch unit includes an upper electrode layer, a lower electrode layer, a liquid crystal layer, and an emitting layer. The oscillator is configured to output a high-frequency current to the upper electrode layers. Each rectifier circuit is configured to convert the high-frequency current to the direct current. Each comparator is configured to determine whether the direct current is less than a reference current. When the touch panel is touched, the high-frequency current deceases. The direct current deceases. The comparator outputs a control signal to turn on the switch. The direct current power supplies electricity to control the liquid crystal molecules to be arranged in order, the light emitted from the emitting layer thus passes through the liquid crystal layer.

### BACKGROUND

1. Technical Field

The present disclosure relates to touch panels and electronic devices and, particularly, to a touch panel with quick response speed and an electronic device using the touch panel.

2. Description of Related Art

Nowadays, electronic devices with touch panels are very popular. Conventionally, when a position of a touch panel is touched by an object, such as a finger or a stylus, the touch panel generates a signal including the touched position and transfers the signal to a processing unit of an electronic device using the touch panel. The processing unit then determines which position is touched according to the signal. As an electronic device using a conventional touch panel needs a processing unit of the electronic device to determine the touched position, which may increase efficiency of the processing unit and but decrease response time of touch operations.

### BRIEF DESCRIPTION OF THE DRAWINGS

The components in the drawings are not necessarily drawn to scale, the emphasis instead being placed upon clearly illustrating the principles of a touch panel and an electronic device using same. Moreover, in the drawings, like reference numerals designate corresponding parts throughout the several views.

FIG. 1 is a schematic view of a touch panel in accordance with an exemplary embodiment.

FIG. 2 is a circuit diagram of a part of the touch panel of FIG. 1.

FIG. 3 is a schematic view of an electronic device using the touch panel of FIG. 1 in accordance with an exemplary embodiment.

### DETAILED DESCRIPTION

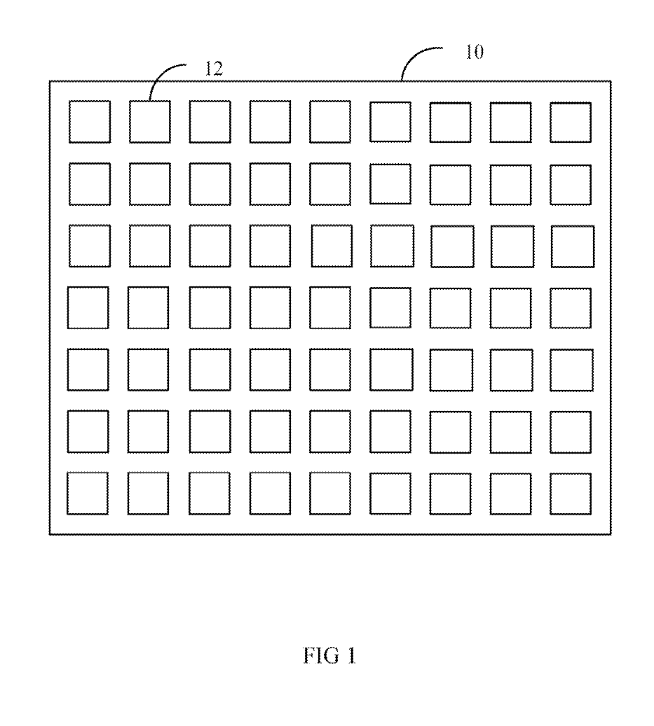

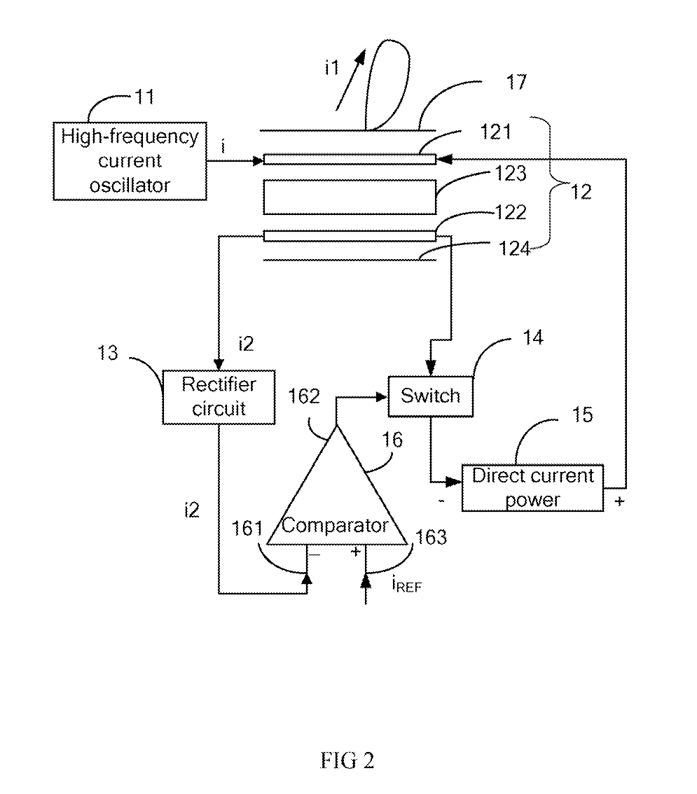

Referring to FIGS. 1-2, a touch panel 10 in accordance with an exemplary embodiment is shown. The touch panel 10 includes a high-frequency current oscillator 11, a number of independent touch units 12, a direct current power 15. For the simplicity of description, only one touch unit 12 is illustrated in FIG. 2, together with its associated circuit components. A circuit for each touch unit 12 includes a rectifier circuit 13, a switch 14, and a comparator 16. The oscillator 11 is configured to supply high-frequency current to the touch units 12. In the exemplary embodiment, the touch units 12 are arranged in a matrix. The number of the touch units 12 can vary according to need.

Each touch unit 12 includes an upper electrode layer 121, a lower electrode layer 122, a liquid crystal layer 123 arranged between the upper electrode layer 121 and the lower electrode layer 122, and an emitting layer 124 arranged below the lower electrode layer 122. The upper electrode layer 121 and the lower electrode layer 122 form a capacitor capable of blocking direct current while allowing alternating current to pass through. In the exemplary embodiment, the upper electrode layer 121 and the lower electrode layer 122 are transparent. The emitting layer 124 is configured to emit light. In the exemplary embodiment, the emitting layer 124 is an electroluminescence element. When the liquid crystal molecules of the liquid crystal layer 123 are arranged in order, the light emitted from the emitting layer 124 can pass through the liquid crystal layer 123. When the liquid crystal molecules of the liquid crystal layer 123 are not arranged in order, the light emitted from the emitting layer 124 cannot pass through the liquid crystal layer 123.

The oscillator 11 is electrically connected to the upper electrode layer 121 of each touch unit 12, and configured to output a high-frequency current “i” to the upper electrode layer 121 of each touch unit 12. The high-frequency current “i” flows from the upper electrode layer 121 to the lower electrode layer 122 of each touch unit 12.

Each rectifier circuit 13 is electrically connected to the lower electrode layer 122 of the touch unit 12 corresponding to the rectifier circuit 13 and configured to convert the high-frequency current flowing from the lower electrode layer 122 to the direct current.

In the exemplary embodiment, each switch 14 is electrically connected among one comparator 16, one lower electrode layer 122, and one DC power 15. In an alternative embodiment, each switch 14 is electrically connected among one comparator 16, one upper electrode layer 121, and one DC power 15. The switch 14 is turned on or turned off according to control signals generated by the comparator 16.

Each comparator 16 includes an input port 161, an output port 162, and a reference current port 163. Each input port 161 is electrically connected to one rectifier circuit 13. Each output port 162 is electrically connected to one switch 14. A reference current i_{REF} equal to the current “i” generated by the oscillator 11 flows into each reference current port 163. Each comparator 16 is configured to compare whether the current flowing from the rectifier circuit 13 connected to each comparator 16 is less than the reference current i_{REF}. If the comparator 16 determines that the current flowing from the rectifier circuit 13 connected to the comparator 16 is less than the reference current i_{REF}, the comparator 16 outputs control signals to turn on the switch 14 connected to the comparator 16. Otherwise, the comparator 16 outputs control signals to turn off the switch 14.

The touch panel 10 further includes a protecting layer 17 arranged on the upper electrode layers 121 to protect the touch panel 10. In the exemplary embodiment, the protecting layer 17 is made of transparent and conductive material.

When the touch panel 10 is not touched, the direct current output by each rectifier circuit 13 is equal to the reference current i_{REF}. Each comparator 16 outputs control signals to turn off the switch 14 connected to the comparator 16. The voltage between the upper electrode layer 121 and the lower electrode layer 122 is zero. The liquid crystal molecules of the liquid crystal layer 123 are not in order, so the light emitted from the emitting layer 124 cannot pass through the liquid crystal layer 123.

When the touch panel 10 is touched by a conductive object, such as a finger or a stylus, a part of the high-frequency current i1 flows to ground. Therefore, the high-frequency current i2 output to the upper electrode layer 121 of the touch unit 12 corresponding to the touched position decreases, and the direct current converted by the rectifier circuit 13 i2 corresponding to the touch unit 12 decreases. The comparator 16 corresponding to the touch unit 12 then outputs a control signal to turn on the switch 14 connected to the comparator 16. When the switch 14 is turned on, the touch unit 12, the switch 14, and the direct current power 15 connected to the switch 14 form a loop. The direct current power 15 supplies electricity to the touch unit 12, causing the liquid crystal molecules of the liquid crystal layer 123 to be arranged in order. The light emitting from the emitting layer 124 thus passes through the liquid crystal layer 123, and the touch unit 12 is illuminated.

Therefore, when touching the touch panel 10 to input information, such as characters, sliding tracks can be displayed on the touch panel 10. Furthermore, as the touch panel 10 can determine which touch unit 12 is touched by itself rather than a processing unit of an electronic device using the touch panel 10, the efficiency and the response time of the processing unit of touch operation both improve.

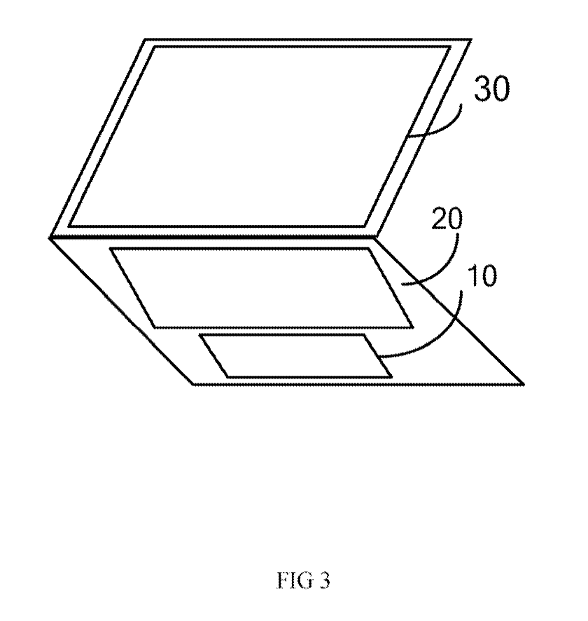

Referring to FIG. 3, an electronic device 100 in accordance with an exemplary embodiment is shown. The electronic device 100 includes the touch panel 10, a main body 20, and a display 30. The touch panel 10 is arranged on the main body 20. The touch panel 10 can be used to input information to the electronic device 100 and/or control visual information displayed on the display 30.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A touch panel comprising:
a plurality of touch units, each of which comprises an upper electrode layer, a lower electrode layer, a liquid crystal layer arranged between the upper electrode layer and the lower electrode layer, and an emitting layer arranged on the bottom of the lower electrode layer;
a high-frequency current oscillator connected to the upper electrode layers of the touch units and configured to output high-frequency current to the upper electrode layers;
a plurality of rectifier circuits, each of which corresponds to one of the touch units, and is electrically connected to the upper electrode layer of the corresponding touch unit and is configured to convert the high-frequency current output by the upper electrode layer of the corresponding touch unit to direct current;
a direct current power, configured to supply electricity to the upper electrode layer and the lower electrode layer of each touch unit;
a plurality of switches, each of which corresponds to one of the touch units and connected between the corresponding touch unit and the direct current power; and
a plurality of comparators, each of which corresponds to one of the touch units and comprises an input port connected to a corresponding one of the rectifier circuits, an output port connected to a corresponding one of the switches, and a reference current port, a reference current equal to the high-frequency current output from the high-frequency current oscillator flowing to the reference current port, and is configured to determine whether the direct current converted by the rectifier circuit connected to the comparator is less than the reference current flowing to the comparator, and output control signals to turn on or turn off the corresponding switch connected to the comparator according to comparing result;
wherein, when a spot of the touch panel is touched, high-frequency the current flows to the upper electrode layer of the touch unit corresponding to the touched position decreases, the direct current converted by the rectifier circuit corresponding to the touch unit decreases, and the comparator outputs control signals to turn on the switch, the direct current power supplies electricity to the touch unit to control the liquid crystal molecules of the liquid crystal layer to be arranged in order, the light emitted from the emitting layer of the touch unit thus passes through the liquid crystal layer of the touch unit.

2. The touch panel as described in claim 1, wherein each of the switches is electrically connected among the output port of the corresponding comparator, the corresponding lower electrode layer, and the direct current power.

3. The touch panel as described in claim 1, wherein each of the switches is electrically connected among the output port of the corresponding one of the comparators, the corresponding one of the upper electrode layers, and the direct current power.

4. The touch panel as described in claim 1, wherein each of the upper electrode layers and each of the lower electrode layers are transparent.

5. The touch panel as described in claim 1, further comprising a protecting layer arranged on each of the upper electrode layers, wherein the protecting layer is made of transparent and conductive material.

6. An electronic device comprising:
a touch panel comprising,
a plurality of touch units, each of which comprises an upper electrode layer, a lower electrode layer, a liquid crystal layer arranged between the upper electrode layer and the lower electrode layer, and an emitting layer arranged on the bottom of the lower electrode layer;
a high-frequency current oscillator electrically connected to the upper electrode layers of the touch units and configured to output high-frequency current to the upper electrode layers;
a plurality of rectifier circuits, each of which corresponds to one of the touch units and is electrically connected to the upper electrode layer of the corresponding touch unit and is configured to convert the high-frequency current output by the upper electrode layer of the corresponding touch unit to direct current;
a direct current power, configured to supply electricity to the upper electrode layer and the lower electrode layer of each touch unit;
a plurality of switches, each of which corresponds to one of the touch units and connected between the corresponding touch unit and the direct current power; and
a plurality of comparators, each of which corresponds to one of the touch units and comprises an input port electrically connected to a corresponding one of the rectifier circuits, an output port electrically connected to a corresponding one of the switches, and a reference current port, a reference current equal to the high-frequency current output from the high-frequency current oscillator flowing to the reference current port, and is configured to determine whether the direct current converted by the rectifier circuit connected to the comparator is less than the reference current flowing to the comparator, and output control signals to turn on or turn off the corresponding switch electrically connected to the comparator according to comparing result;
wherein, when a spot of the touch panel is touched, the high-frequency current flows to the upper electrode layer of the touch unit corresponding to the touched position decreases, the direct current converted by the rectifier circuit corresponding to the touch unit decreases, and the comparator outputs control signals to turn on the switch, the direct current power supplies electricity to the touch unit to control the liquid crystal molecules of the liquid crystal layer to be arranged in order, the light emitted from the emitting layer of the touch unit thus passes through the liquid crystal layer of the touch unit.

7. The electronic device as described in claim 6, wherein each of the switches is electrically connected among the output port of the corresponding comparator, the corresponding lower electrode layers, and the direct current power.

8. The electronic device as described in claim 6, wherein each of the switches is electrically connected among the output port of the corresponding comparators, the corresponding upper electrode layers, and the direct current power.

9. The electronic device as described in claim 6, wherein each of the upper electrode layer and each of the lower electrode layer are transparent.

10. The electronic device as described in claim 6, further comprising a protecting layer arranged on the upper electrode layer, the protecting layer is made of transparent and conductive material.
